(19) United States
(12) Patent Application Publication
(10) Pub. No.: US 2007/0065061 A1
(43) Pub. Date: Mar. 22, 2007

(54) Crankshaft supporting structure

(76) Inventors: Takanori Terada, Iwata-shi (JP); Takaaki Sakai, Iwata-shi (JP); Akihiko Katayama, Iwata-shi (JP); Rino Fukami, Iwata-shi (JP); Makoto Nishikawa, Iwata-shi (JP); Shinji Oishi, Iwata-shi (JP)

Correspondence Address: CLARK & BRODY, 1090 VERMONT AVENUE, NW, SUITE 250, WASHINGTON, DC, 20005, US

(21) Appl. No.: 11/523,071

(22) Filed: Sep. 19, 2006

(30) Foreign Application Priority Data
Sep. 21, 2005 (JP) JP2005-274469
Sep. 26, 2005 (JP) JP2005-277852
Nov. 4, 2005 (JP) JP2005-321409

(51) Int. Cl. F16C 9/00

(52) U.S. Cl. 384/457

(57) ABSTRACT

A needle roller bearing supporting the shaft part of a crankshaft comprises an outer ring having a plurality of outer ring members divided by parting lines extending in the axial direction of the bearing, a plurality of needle rollers arranged on the track surface of the outer ring such they can roll, and a retainer having pockets for housing the plurality of needle rollers. Thus, the roundness of the inner diameter surface of the outer ring is set within the range of 0 μm to 20 μm.

### BACKGROUND OF THE INVENTION

1. Field of the Invention

The present invention relates to a roller bearing supporting a crankshaft used in a car engine and a crankshaft supporting structure.

2. Description of the Background Art

As shown in FIG. 23, a crankshaft 101 comprises a shaft part 102, a crank arm 103, and a crank pin 104 for arranging a con-rod between the adjacent crank arms 103. As shown in FIG. 24, the shaft part 102 is supported by a sliding bearing 110 rotatably. Alternatively, as shown in FIG. 25, the shaft part 102 is supported by a needle roller bearing rotatably.

As the bearing 105 supporting the shaft part 103, the needle roller bearing 105 comprising an outer ring 106, needle rollers 107 arranged along the inner diameter surface of the outer ring 106, and a retainer 108 retaining the interval between the adjacent needle rollers 107 is used as shown in FIG. 26, for example.

According to such needle roller bearing 105, since the needle roller 107 and the track surface are in line contact with each other, there is an advantage such that high load capacity and high rigidity can be provided for a small bearing projected area, so that it can be used widely in various fields of a car, a two wheel vehicle and the like. In addition, although the needle roller bearing 105 has low load capacity as compared with the sliding bearing, since its friction resistance is small at the time of rotation, a rotation torque and an oil feeding amount at the supporting part can be reduced.

However, since the crank arms 103 are arranged at both ends of the shaft part 102 as shown in a part P in FIG. 25, the needle roller bearing 105 cannot be inserted in the axial direction. Thus, a bearing that can be used at this place is disclosed in U.S. Pat. No. 1,921,488.

The needle roller bearing disclosed in the above document comprises an outer ring having outer ring members 109a and 109b divided by parting lines 109c extending in the axial direction of the bearing as shown in FIG. 27., and a similarly divided-type retainer similarly divided into two parts(not shown). Alternatively, an outer ring 119 may comprise outer ring members 119a and 119b divided by parting lines 119c that are inclined at a predetermined angle with respect to the axial direction as shown in FIG. 28.

According to the needle roller bearing disclosed in the above document, when incorporated into the shaft part 102 sandwiched by the crank arms 103 of the crankshaft 101, the retainer housing the needle rollers and the outer ring members 109a and 109b can be incorporated from the diameter direction.

FIGS. 30A and 30B show the outer ring 109 fitted in the shaft part 102 viewed from the axial direction. Here, the needle roller is not shown. FIG. 30A is an ideal state after the bearing is incorporated, in which the outer ring 109 is a perfect circle. In this case, since the space formed between the shaft part 102 and the inner diameter surface of the outer ring 109 in which the needle roller rolls (referred to as the “rolling space” hereinafter) is constant over the circumference, the needle rollers can roll stably.

However, according to the real incorporated state, the perfect circle cannot be provided when the outer ring members 109a and 109b are combined, so that the rolling space is not constant on the circumference as shown in FIG. 30B. In this case, when the needle roller passes through the vicinity of the abutment part of the outer ring members 109a and 109b in which the rolling space is narrow, an abnormal noise is generated. This abnormal noise becomes loud as the roundness of the outer ring 109 is lowered. In addition, it becomes loud as the rotation speed of the bearing becomes high, which is a big problem for the bearing that supports the shaft that rotates at high speed such as the crankshaft 101.

In addition, according to the needle roller bearing 105 having the above constitution, while its torque loss at the time of the rotation of the bearing is small as compared with the sliding bearing, its load capacity is inferior. Therefore, the needle roller bearing 105 has a disadvantage in forming an oil film and a trouble such as early separation could be generated.

In addition, since rising of oil pressure in an oil pump is less advanced than the start of the engine for a few seconds just after the engine is started, supply of the lubricating oil is delayed. As a result, seizing and the like could be generated due to a lubrication defect.

A method for dividing the outer ring 109 is disclosed in Japanese Unexamined Patent Publication No. 7-317778, for example. According to this document, a groove 109d having a V shape (referred to as the “V-shaped groove” hereinafter) is formed on each end face of the outer ring 109 as shown in FIG. 29A, and when a pressure is applied from both sides to the positions of the V-shaped grooves 109d in the diameter direction, the outer ring 109 is divided into two outer ring members 109a and 109b as shown in FIG. 29B.

Meanwhile, as a method for dividing the retainer, a cutting method with a cutting machine using a grind stone is employed in general. In this method, when the divided retainers are combined, a clearance is formed at the cut part by a width of the grind stone.

As one method for reducing the clearance of the divided retainers in the circumferential direction, it is considered that the width of the grind stone is reduced. However, in this case, the grind stone could be damaged during the processing. In addition, as another method, a method in which one semicircle-shaped divided-type retainer from each of two retainers is picked up and they are combined is considered. However, since the other divided retainers that are smaller than the semicircle have to be scraped, the yield rate of the material becomes high and its manufacturing cost is increased.

### SUMMARY OF THE INVENTION

It is an object of the present invention to provide a crankshaft supporting structure that can prevent an abnormal noise when a needle roller passes through the vicinity of the abutment part of outer ring members.

It is another object of the present invention to provide a crankshaft supporting bearing that is superior in lubricating property and has a long life.

It is still another object of the present invention to provide a crankshaft supporting structure using a needle roller bearing in which its cost is reduced by dividing a retainer by a more simple method.

A crankshaft supporting structure according to the present invention comprises a crankshaft and a needle roller bearing supporting the crankshaft rotatably. Regarding the needle roller bearing, it comprises an outer ring having a plurality of outer ring members divided by parting lines extending in the axial direction of the bearing and a plurality of needle rollers arranged on the track surface of the outer ring such that they can roll, and the roundness of the outer ring is within the range of 0 to 20 μm.

According to the above constitution, since the rolling space on the circumference of the outer ring is almost constant, an abnormal noise generated when the needle roller passes through the vicinity of the abutment part of the outer ring members can be suppressed. As a result, the crankshaft supporting structure has a low noise level.

Preferably, the needle roller bearing comprises a track ring and a plurality of rolling elements arranged along the track ring as bearing components. At least either one of the bearing components has numerous fine depressions formed on its surface at random. As described above, since the numerous fine depressions are formed in the surface of the bearing component, an oil film forming ability is improved and an oil film having a sufficient thickness can be formed even under thin lubrication condition just after an engine is started.

Preferably, an area ratio of the depressions to a surface area of the bearing component is within the range of 10 to 40%. When the area ratio of the depressions is less than 10%, the oil film forming ability is low and the oil film having a sufficient thickness cannot be formed just after the engine is started especially. Meanwhile, when the area ratio of the depressions is more than 40%, the contact area of the rolling surface is reduced and the lubricating performance deteriorates.

Preferably, the surface roughness parameter Sk value of the bearing component is not more than −1.6. When the surface roughness parameter of the baring component is set within the above range, since the oil forming property is improved, the crankshaft supporting roller bearing is superior in durability.

In addition, the “Sk value” in this specification designates skewness of a roughness curve (ISO4287 : 1997), and shows a statistics value as rough indication for knowing the asymmetry of an irregular distribution. This value becomes close to zero in a case of a symmetric distribution like Gaussian distribution, and when a projection is removed from the irregular distribution, it takes a negative value and in its reverse case, it takes a positive value. In addition, the Sk value can be controlled by selecting the rotation speed of a barrel grinding machine, a processing time, a work input amount, the kind and size of a chip and the like.

Preferably, the needle roller bearing further comprises a retainer having cut parts extending in the axial direction of the bearing at a plurality of positions on its circumference, and the retainer has a V-shaped groove in section at a position corresponding to the cut part and it is cut at the root part of the groove as a base point. According to the above retainer dividing method, the clearance formed between the cut parts can be easily reduced. As a result, the needle roller bearing can be provided at low manufacturing cost.

Preferably, the retainer is formed of carbon steel whose carbon content is not less than 0.15% but not more than 1.1%. When the carbon content is less than 0.15%, a sufficient heat treatment effect cannot provided. Meanwhile, when the carbon content is more than 1.1%, processing becomes very difficult. Thus, when the carbon content is within the above range, the needle roller bearing is superior in quenching property and workability.

Preferably, the depth “t” of the groove and the thickness “w” of the retainer has a relation such that 0.03≦t/w≦0.15. When t/w<0.03, it is difficult to divide the retainer straight along the V-shaped groove, and when 0.15<t/w, the thickness of the retainer is too small to secure its strength. Thus, when the relation is within the above range, the needle roller bearing is superior in workability and has high strength.

A crankshaft supporting structure according to the present invention comprises a crankshaft and the above needle roller bearing supporting the crankshaft rotatably. When the needle roller bearing in which the retainer is divided by the above method is used, the crankshaft supporting structure can be provided at low cost.

According to the present invention, the crankshaft supporting structure can suppress the abnormal noise due to the rolling of the needle roller and has a low noise level by improving the roundness of the outer ring.

In addition, according to the present invention, the crankshaft supporting roller bearing can improve its oil film forming property and has superior durability by providing the fine depressions on the surface of the bearing component.

Furthermore, according to the present invention, since the clearance between the cut parts can be easily reduced by dividing the retainer from the root part of the V-shaped groove provided on the circumference of the retainer as the base point, the needle roller bearing can be provided at low manufacturing cost. In addition, when such needle roller bearing is used, the crankshaft supporting structure can be provided at low cost.

### BRIEF DESCRIPTION OF THE DRAWINGS

FIG. 1 is a view showing the measured result of the outer ring roundness of a needle roller bearing used in FIG. 2;

FIG. 2 is a view showing a crankshaft supporting structure according to one embodiment of the present invention;

FIG. 3A is a front view showing the outer ring member of the needle roller bearing in FIG. 2 before divided;

FIG. 3B is a view showing the outer ring member of the needle roller bearing in FIG. 2 in which the outer ring member in FIG. 2 is divided at two points;

FIG. 3C is a view showing the outer ring member of the needle roller bearing in FIG. 2 in which the divided part in FIG. 3B is enlarged;

FIG. 4A is a front view showing a retainer of the needle roller bearing in FIG. 2;

FIG. 4B is a side sectional view showing the retainer of the needle roller bearing in FIG. 2;

FIG. 5 shows the measured result of the roundness of the outer ring in which the roundness is 20 μm;

FIG. 6 shows a measured result of the roundness of the outer ring in which the roundness is 26 μm;

FIG. 7 shows a measured result of the roundness of the outer ring in which the roundness is 40 μm;

FIG. 8 is a view showing a test result for confirming the effect of the present invention;

FIG. 9 is a view showing a crankshaft supporting structure according to one embodiment of the present invention;

FIG. 10A is a side view showing a retainer of a needle roller bearing shown in FIG. 9;

FIG. 10B is an enlarge view of a cut part of the retainer of the needle roller bearing shown in FIG. 9;

FIG. 11A is a view showing a state taken from an axial direction after the crankshaft supporting structure according to one embodiment of the present invention is incorporated;

FIG. 11B is a view showing a state taken from the direction vertical to the shaft after the crankshaft supporting structure according to one embodiment of the present invention is incorporated;

FIG. 12 is a schematic view showing a radial load testing machine used in the test for confirming the effect of the present invention;

FIG. 13 is a view showing a needle roller bearing used in the effect confirming test;

FIG. 14 is a view showing a state of the surface of a component after a surface treatment shown in Table 1 is performed;

FIG. 15 is a view showing a surface state of a component to which the surface treatment is not performed;

FIG. 16A is a view showing a characteristic part of the present invention in which a part of steps of dividing the retainer is shown;

FIG. 16B is a view showing a characteristic part of the present invention in which a part of steps of dividing the retainer is shown;

FIG. 17 is a view showing a crankshaft supporting structure according to one embodiment of the present invention;

FIG. 18A is a view showing a configuration of a pillar part of a retainer of a needle roller bearing shown in FIG. 17;

FIG. 18B is a view showing the position of a V-shaped groove of the retainer of the needle roller bearing shown in FIG. 17;

FIG. 18C is a view showing the size of the V-shaped groove of the retainer of the needle roller bearing shown in FIG. 17;

FIG. 19A is a view showing another example of a retainer for a needle roller bearing used in the present invention;

FIG. 19B is a view in which the FIG. 19A is taken from the outside in a diameter direction;

FIG. 20A is a view showing another example of a retainer for a needle roller bearing used in the present invention;

FIG. 20B is a view in which FIG. 20A is taken from the outside in the diameter direction;

FIG. 21 is a view showing another example in which a retainer of a needle roller bearing used in the present invention is divided;

FIG. 22 is a view showing another example in which a retainer of a needle roller bearing used in the present invention is divided;

FIG. 23 is a view showing a conventional crankshaft;

FIG. 24 is an enlarged view showing a part P in FIG. 23;

FIG. 25 is a view showing another configuration of the part P in FIG. 23;

FIG. 26 is a view showing a needle roller bearing supporting a shaft part of the conventional crankshaft;

FIG. 27 is a view showing a conventional divided outer ring;

FIG. 28 is a view showing another example of a conventional divided outer ring;

FIG. 29A is a view showing a V-shaped groove formed in the outer ring in FIG. 27;

FIG. 29B is a view showing a conventional method for dividing the outer ring in FIG. 27;

FIG. 30A is a view showing an example in which an inner diameter surface is a perfect circle when the outer ring members in FIG. 27 are combined; and

FIG. 30B is a view showing an example in which an inner diameter surface is not a perfect circle when the outer ring members in FIG. 27 are combined.

### DESCRIPTION OF THE PREFERRED EMBODIMENTS

A crankshaft supporting structure according to one embodiment of the present invention will be described with reference to FIG. 2 hereinafter.

A crankshaft supporting structure shown in FIG. 2 comprises a crankshaft 15 having a shaft part 16, crank arms 17 positioned at both ends of the shaft part 16 and a crank pin 18 arranged on opposite side of the shaft part 16 at the crank arm 17, a needle roller bearing 11 supporting the crankshaft 15 rotatably, a crank case 19 , and a crank case cap 20 .

The needle roller bearing 11 comprises an outer ring 12 having a plurality of outer ring members 12a divided by parting lines extending in the axial direction of the bearing, a plurality of needle rollers arranged and rolling on the track surface of the outer ring 12 and a retainer 14 having pockets for housing the plurality of needle rollers.

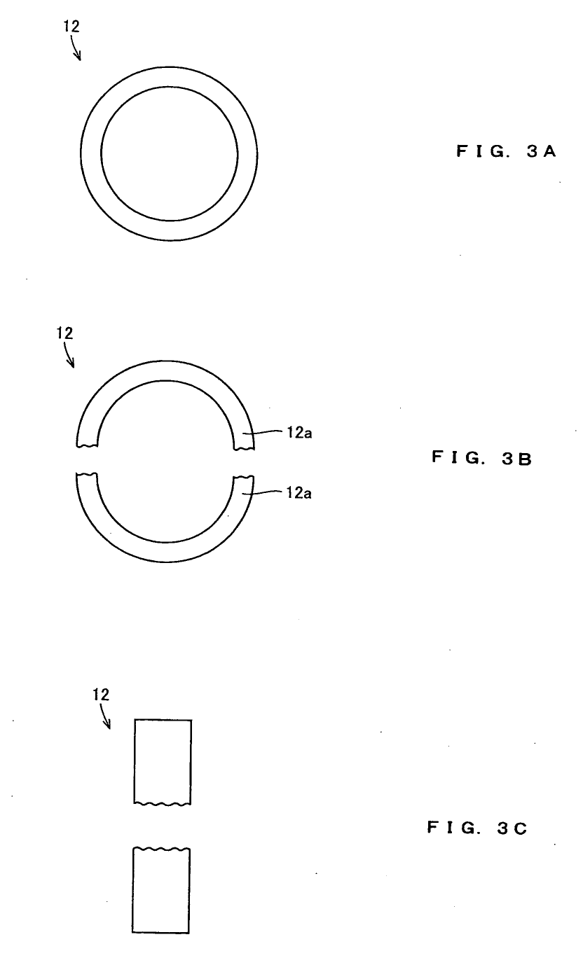

An outer ring member 12a is provided such that the cylindrical outer ring 12 formed through a cutting process as shown in FIG. 3A is shocked and dually divided in the circumferential direction (refer to FIG. 3B). At this time, since the grinding process and the like is not performed on the end surface of the divided part, a corrugated surface generated when the outer ring 12 is divided is left as shown in FIG. 3C. When the bearing is used, the cylindrical outer ring 12 is provided by butting corresponding surfaces with each other. In addition, such manufacturing method is called “natural cracking”. Although the outer ring comprises two outer ring members 12a in the above example, the outer ring is not limited to this and it may comprise three or more outer ring members 12a.

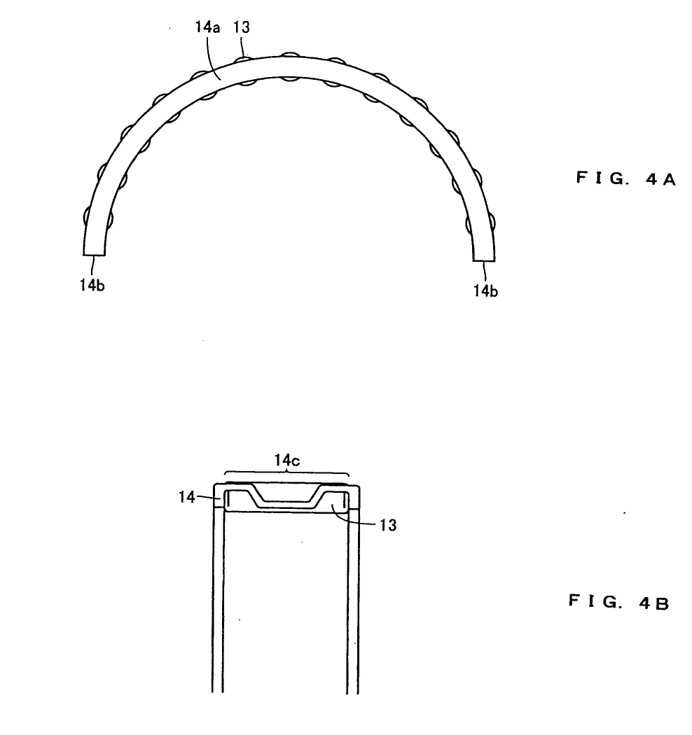

Meanwhile, the retainer 14 is formed by combining divided retainers 14a divided at cut parts 14b in the circumferential direction as shown in FIG. 4A. In addition, as shown in FIG. 4B, it comprises pockets 14c for housing the needle rollers 13.

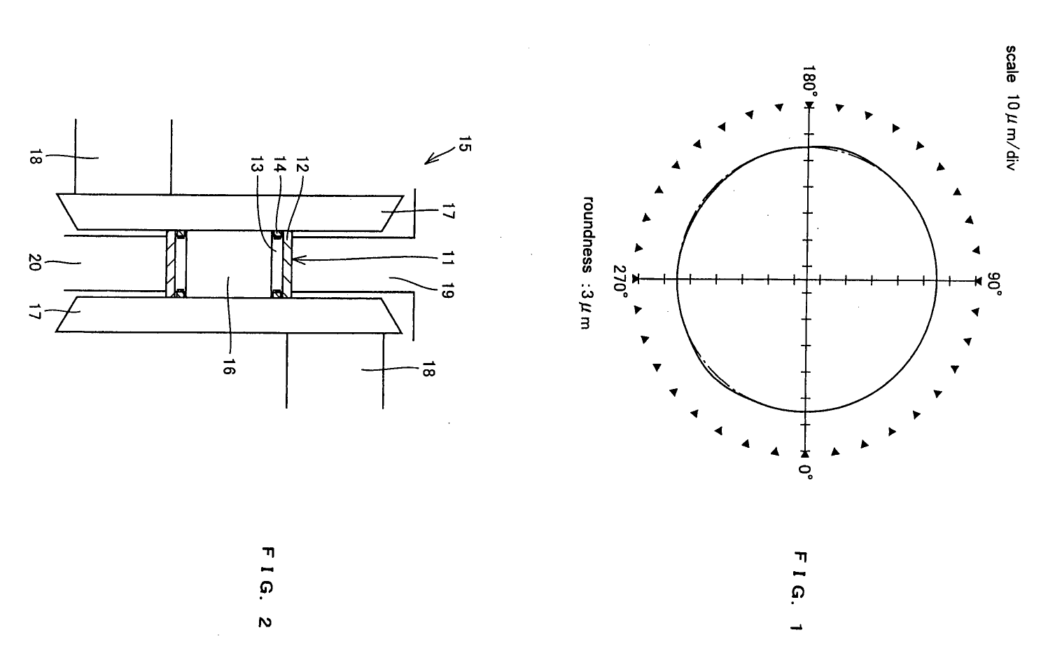

Here, the roundness of the inner diameter surface of the two outer ring members 12a when the needle roller bearing 11 having the above constitution is incorporated in the shaft part 16 is set to around 3 μm as shown in FIG. 1. According to the above constitution, since a rolling space on the circumference of the outer ring 12 is almost the same, an abnormal noise caused by rolling of the needle roller can be suppressed. As a result, the crankshaft supporting structure has a low noise level. In the drawings, a chain line shows a perfect circle and a solid line shows the inner diameter surface of the outer ring shifted from the perfect circle.

In view of preventing the noise, although it is better that the inner diameter surface of the outer ring is close to the perfect circle as much as possible, it is very difficult to implement the roundness of 0 μm from manufacturing and assembling viewpoints. In addition, the higher the roundness, the higher the manufacturing cost.

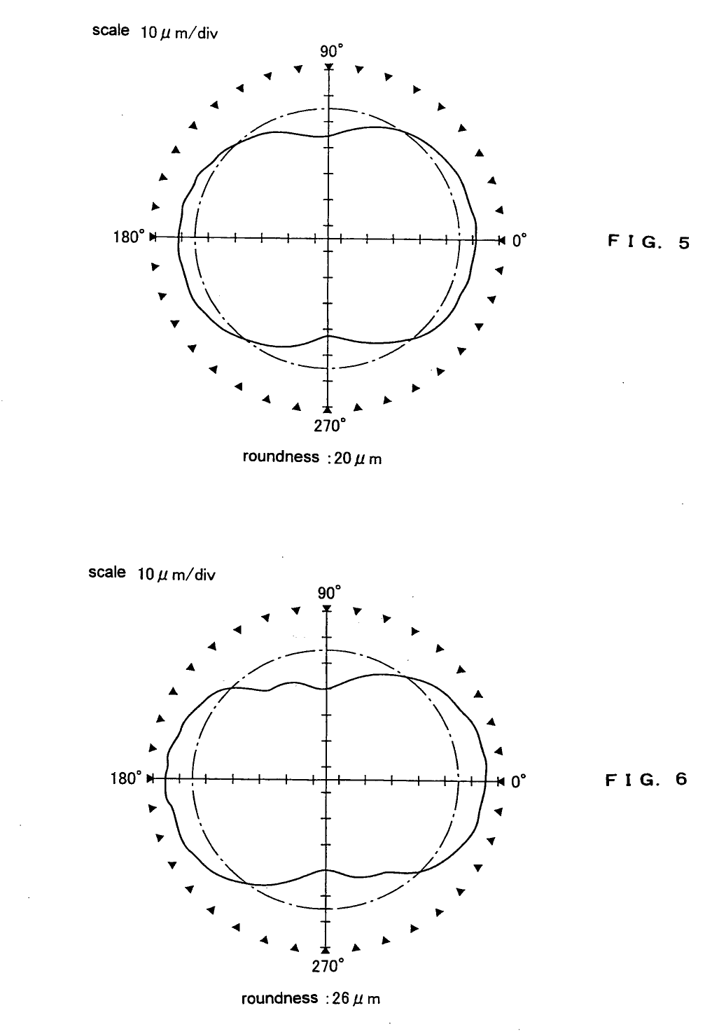

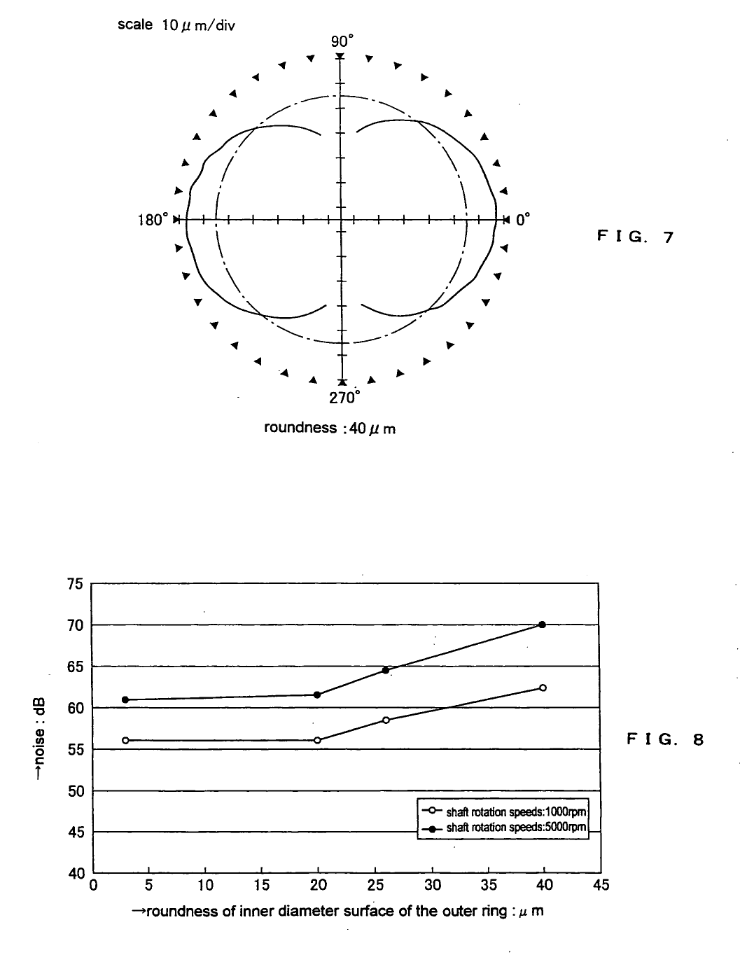

Thus, it has been confirmed that how much roundness is required for the inner diameter surface of the outer ring in practical use by performing the following test. In the test, outer ring members having the roundness of 3 μm shown in FIG. 1, outer ring members having the roundness of 20 μm shown in FIG. 5, outer ring members having the roundness of 26 μm shown in FIG. 6, and outer ring members having the roundness of 40 μm shown in FIG. 7 were prepared and bearing rotation speeds were set to 1000 rpm and 5000 rpm. The result of the test is shown in Table 1and FIG. 8.

TABLE 1

| | |
|---|---|
| Roundness of | Bearing |
| inner diameter | rotation speeds |

| surface of the outer ring | 1000 rpm | 5000 rpm |
|---|---|---|
| 3 μm | 56.0 [dB] | 50.8 [dB] |
| 20 μm | 56.2 [dB] | 61.5 [dB] |
| 26 μm | 59.5 [dB] | 66.5 [dB] |
| 40 μm | 62.3 [dB] | 70.1 [dB] |

Referring to Table 1and FIG. 8, it was confirmed that the sound loudness was almost the same in the bearings having the roundness of 3 μm and 20 μm, while the sound becomes louder in proportion to the roundness in the bearing other than the above. Thus, it is desirable that the roundness of the inner diameter surface of the outer ring is set within the range of 0 μm to 20 μm from the noise viewpoint. However, in view of the manufacturing point, it is considered that the roundness of the inner diameter surface of the outer ring may be 3 μm to 20 μm.

A method for incorporating the needle roller bearing 11 having the above constitution into the crankshaft 15 will be described hereinafter.

First, the needle roller 13 is incorporated in each pocket of the retainer 14. Next, the one outer ring member 12a is incorporated in the crank case 19, and then the one divided-type retainer 14a, the crankshaft 15, the other retainer 14a and the other outer ring member 12a are set thereon. Finally, the crank case cap 20 is incorporated and fixed. According to the above incorporating steps, they can be incorporated in the shaft whose both ends are sandwiched by the crank arms.

In addition, although the outer ring 12 comprises the two outer ring members 12a in the above example, the present invention is not limited to this. Three or more outer ring members 12a may be combined.

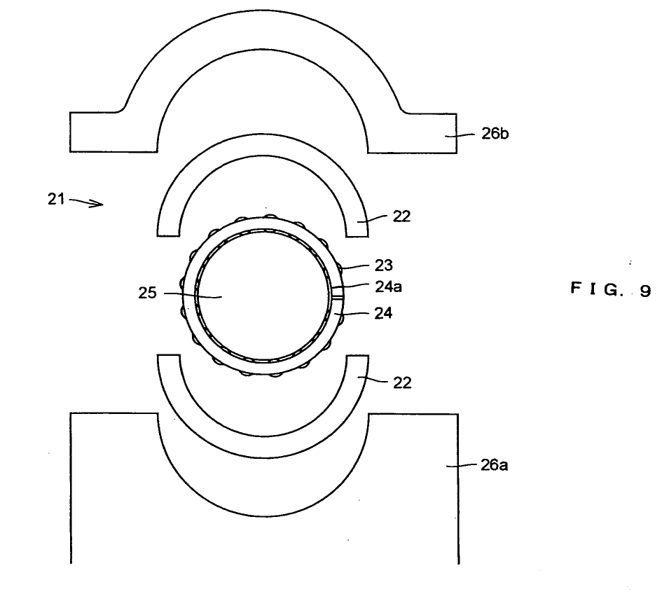

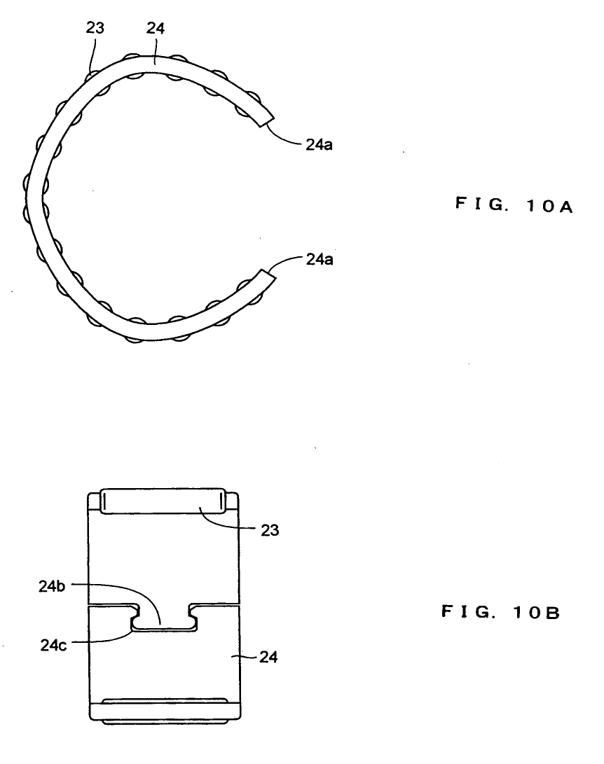

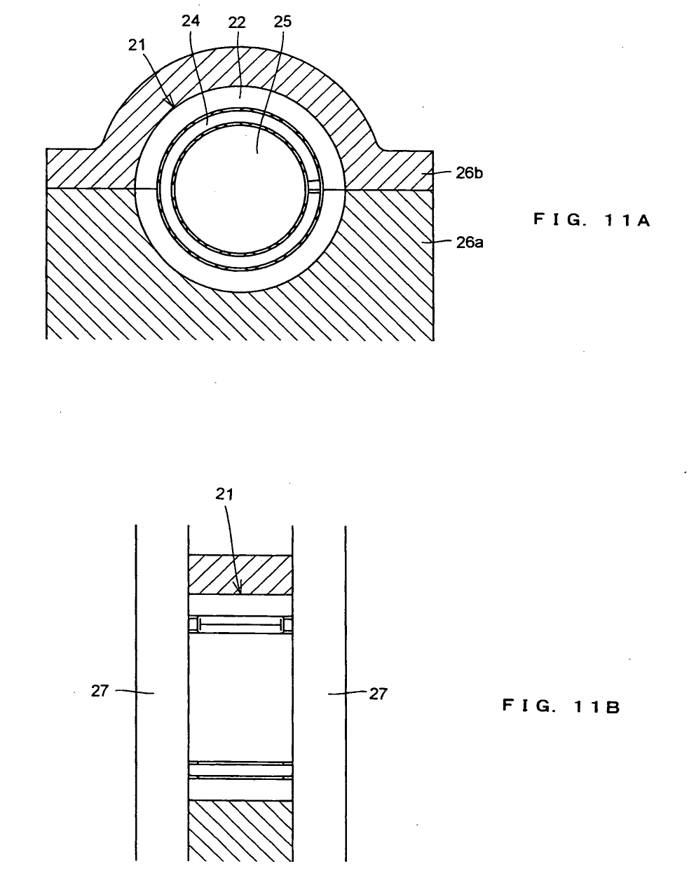

A crankshaft supporting bearing according to another embodiment of the present invention will be described in reference to FIG. 9. Here, the common point to the above embodiment is omitted and a point different from the above embodiment will be described.

A crankshaft supporting structure shown in FIG. 9 comprises a crankshaft 25, an engine block 26a, a bearing cap 26b, and a needle roller bearing 21 arranged between the crankshaft 25 and the bearing cap 26b and supporting the crankshaft 25 rotatably.

The needle roller bearing 21 comprises an outer ring serving as a track ring having a plurality of outer ring members 22 divided by parting lines extending in the axial direction of the bearing, a plurality of needle rollers arranged on the track surface of the outer ring such that it can roll, and an integrated retainer having a cut part 24a extending in the axial direction at one position on the circumference. In addition, since the outer ring member 22 is similar to the outer ring members 12a and 12b shown in FIGS. 3A to 3C, its description will be omitted.

The retainer 24 is the integrated retainer having the one cut part 24a on the circumference as shown in FIG. 10A and one end of the cut part 24a has a projected part 24b and the other end thereof has a recessed part 24c. The projected part 24b and the recessed part 24c are fitted in each other and fixed when the bearing is incorporated.

According to the needle roller bearing 21 having the above constitution, in order to improve the lubricating performance when the bearing rotates, numerous fine depressions are provided at random on the surface of the bearing components, that is, on the track surface of the outer ring and/or the rolling surface of the needle roller 23. Thus, an oil film forming ability is improved and the bearing 21 has a long life even under the condition that an oil film is extremely thin in rare lubrication.

At this time, a Sk value is set to −1.6 or less and an area ratio of the depressions to the surface area of the bearing components is set within the range of 10 to 40%. As its processing method, although a desired finished surface can be provided by a specific barreling, a shot peening or a short blasting may be used.

Thus, the fine depression becomes an oil reservoir, so that the oil film can be satisfactorily formed and the surface is prevented form being damaged. In addition, when the area ratio of the depressions is less than 10%, the number of the fine depressions is too small and the life is shortened. Meanwhile, when the area ratio of the depressions is more than 40%, the contact area of the rolling surface is reduced and the life is also shortened.

One example of the measuring method and the condition of the Sk value is shown below. In a case where the surface property of the roller is measured by this measuring method, for example, although a value measured at one point is reliable as a representative value, when the measurement is performed at two points opposed to each other, a more reliable measured result can be provided.
Parameter calculation standard: Gaussian
Measured length: 5λ
Cut-off wavelength: 0.25 mm
Measured magnification: 10000 times
Measured speed: 0.30 mm
Measured position: Roller center
Measured numbers: 2 points
Measuring instrument: Surface roughness measuring instrument,

### SURFCOM 1400A (produced by Tokyo Seimitsu)

In addition, the quantitative measurement of the depression can be performed such that the surface of the roller is magnified and its image is analyzed with an image analysis system available in the market, for example. Furthermore, with a surface inspecting method and a surface property inspecting device disclosed in Japanese Unexamined Patent Publication No. 2001-183124, the measurement can be made with high precision. When the quantitative measurement of the depression is performed by this method, a white part is analyzed as a surface flat part and a black part is analyzed as fine depressions in the image.

One example of the measurement condition by the measuring device disclosed in the above document is shown below. In this case also, although a value measured at one point is reliable as a representative value, when the measurement is performed at two points opposed to each other, a more reliable measured result can be provided.
Observed viewing field: 826 μm×620 μm
(When the diameter of the roller is less than φ4, 413 μm×310 μm is preferable.)
Measured position: Roller center
Measured numbers: Two points

A method for incorporating the needle roller bearing 21 having the above constitution into the crankshaft 25 will be described hereinafter.

First, the retainer 24 incorporating the needle roller 23 in its pocket previously is prepared. Next, the retainer 24 is incorporated. At this time, the cut part 24a is elastically deformed so as to be able to be incorporated in the crankshaft 25 and the projected part 24b of the retainer is fitted in the recessed part 24c thereof to be fixed to the crankshaft 25. Finally, the outer ring member 22 is incorporated from the diameter direction of the crankshaft 25 and the cylinder block 26a and the bearing cap 26b are incorporated on its outer side.

As a result, the crankshaft 25, the retainer 24, the outer ring member 22, and the inner diameter surfaces of the cylinder block 26a and the bearing cap 26b are concentrically arranged as shown in FIGS. 11A and 11B, so that the needle roller 23 can roll stably.

According to the above incorporating steps, the needle roller bearing 21 can be incorporated in the shaft part whose both ends are sandwiched by the crank arms. Furthermore, according to the needle roller bearing 21, the retainer 24 can be secure from dropping off when the outer ring member 22 is incorporated. Therefore, the incorporating operation becomes easy and a special member for preventing the retainer 24 from dropping off is not needed. As a result, the number of operations and the operation cost can be reduced.

At this time, although the retainer 24 may be a metal retainer manufactured such that a metal material is pressed or cut, when it is a resin retainer manufactured such that a resin material having high elastic deformability is injection molded, the incorporating operation can be further simplified.

In addition, although the outer ring comprises two outer ring members 22 in the above example, three or more outer ring members 22 may be combined. Furthermore, although the integrated retainer has the one cut part 24a on the circumference in the above example, the retainer may have a plurality of cut parts on the circumference.

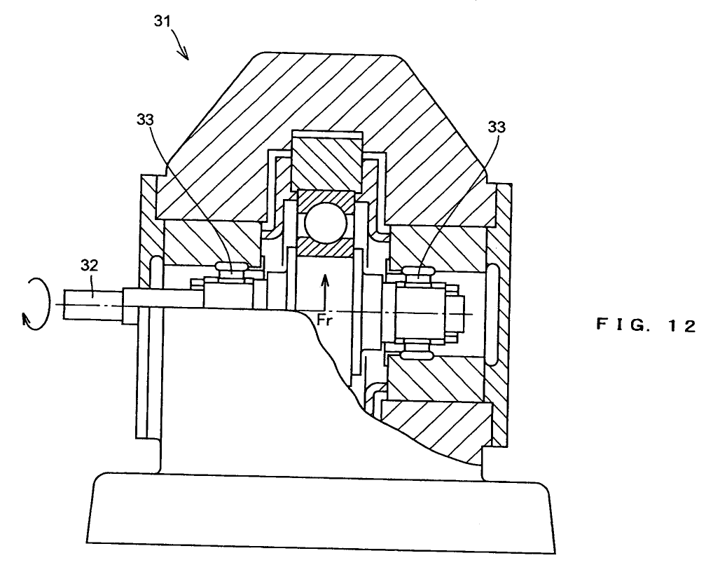

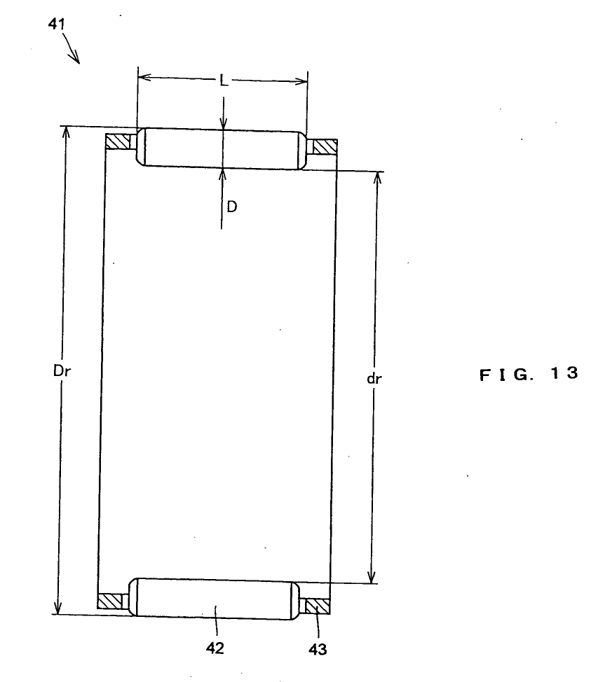

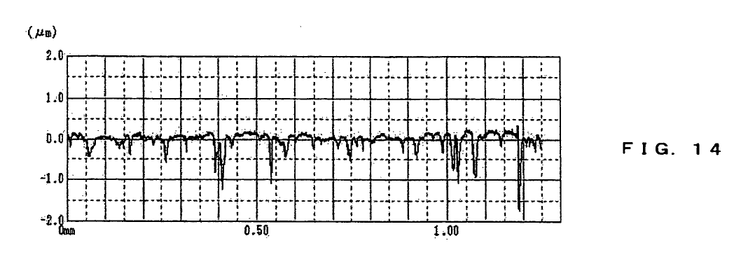

Then, in order to confirm the effect of the present invention, a rotation test was performed such that a load was applied to a test bearing 33 mounted on both sides of a rotation shaft 33, using a radial loading test apparatus 31 shown in FIG. 12, for example. In addition, the surface roughness Ra of the track rings of the rotation shaft 32 and the test bearing 33 is set within the range of 0.10 to 0.16 μm and the test condition is as follows.
Bearing radial load: 2000 kgf
Rotation speed: 4000 rpm
Lubricating oil: CLESAFE oil H46

As the bearing used in the above test, a needle roller bearing 41 comprising needle rollers 42 and a retainer 43 having pockets for housing the needle rollers 42 shown in FIG. 13, in which the outer diameter Dr of the needle roller bearing 41 is 33 mm, the inner diameter dr thereof is 25 mm, the diameter D of the needle roller 42 is 4 mm, and the length L thereof is 25.8 mm and 15 needle rollers are incorporated is used.

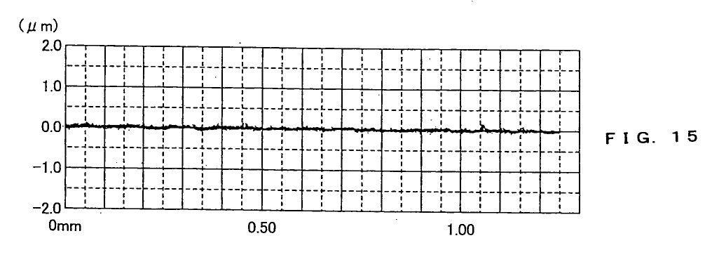

In addition, a surface processing has been performed on the needle roller bearing according to one embodiment of the present invention in order to provide the surface property shown in the upper part in Table 2, and its surface state is shown in FIG. 14. Meanwhile, the surface processing is not performed on the conventional needle roller bearing to be compared, and its surface property and surface state are shown in the lower part in Table 2 and FIG. 15, respectively.

TABLE 2

| Bearing | Rsk | Area ratio(%) | Fatigue life |
|---|---|---|---|
| Bearing according | −5.0˜−1.6 | 10˜40 | 1.7 |
| to the present | | | |
| invention | | | |
| Bearing according | −0.8˜0.9 | — | 1 |
| to the conventional | | | |

Referring to Table 2, it was confirmed that the fatigue life of the bearing according to the present invention was 1.7 times as long as that of the conventional bearing.

In addition, although the needle roller bearing is used for supporting the shaft part of the crankshaft in above each embodiment, the present invention is not limited to this. A roller bearing comprising an inner ring, an outer ring, a rolling element, and a retainer may be used. In this case, the above surface processing is performed for at least one bearing component among the inner ring, the outer ring and the rolling element.

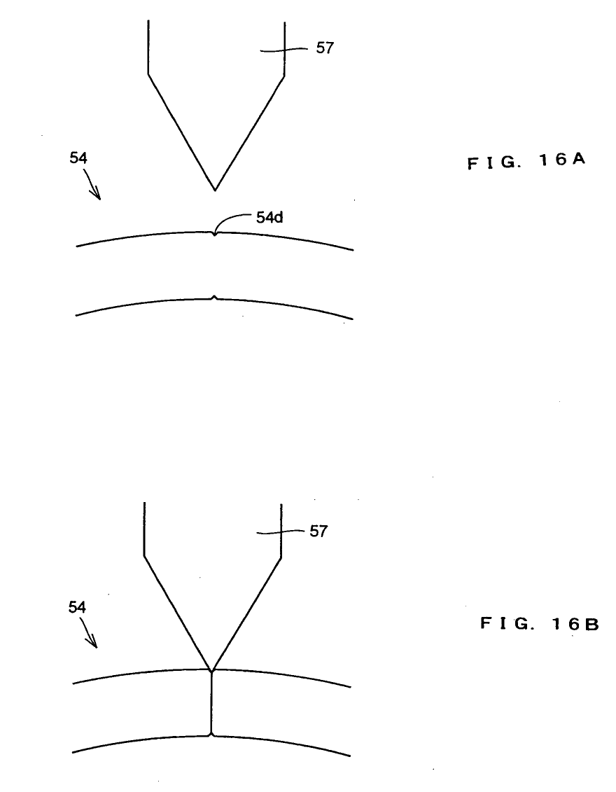

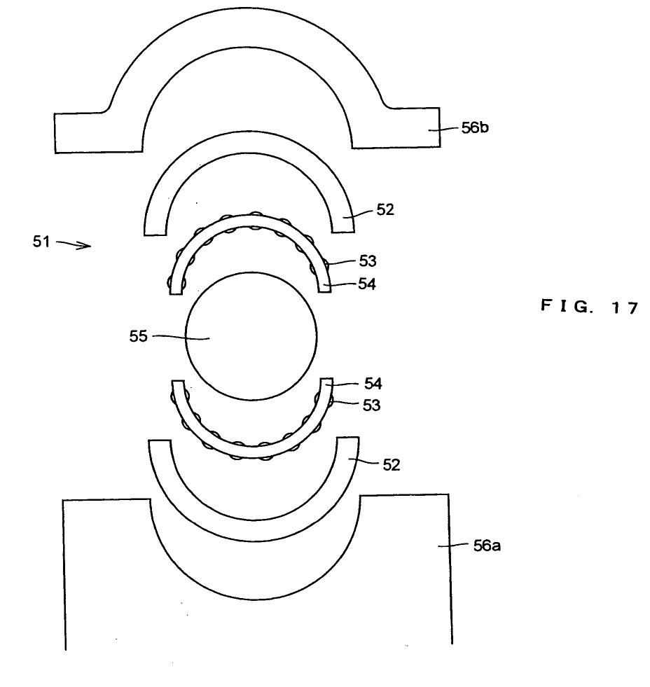

A crankshaft supporting structure according to another embodiment of the present invention will be described with reference to FIGS. 16A to FIG. 19B hereinafter. In addition, the description for the point common to the above each embodiment will be omitted and a different point will be described.

A crankshaft supporting structure shown in FIG. 17 comprises a crankshaft 55, a cylinder block 56a, a bearing cap 56b, and a needle roller bearing 51 arranged between the crankshaft 55 and the bearing cap 56b and supporting the crankshaft 55 rotatably.

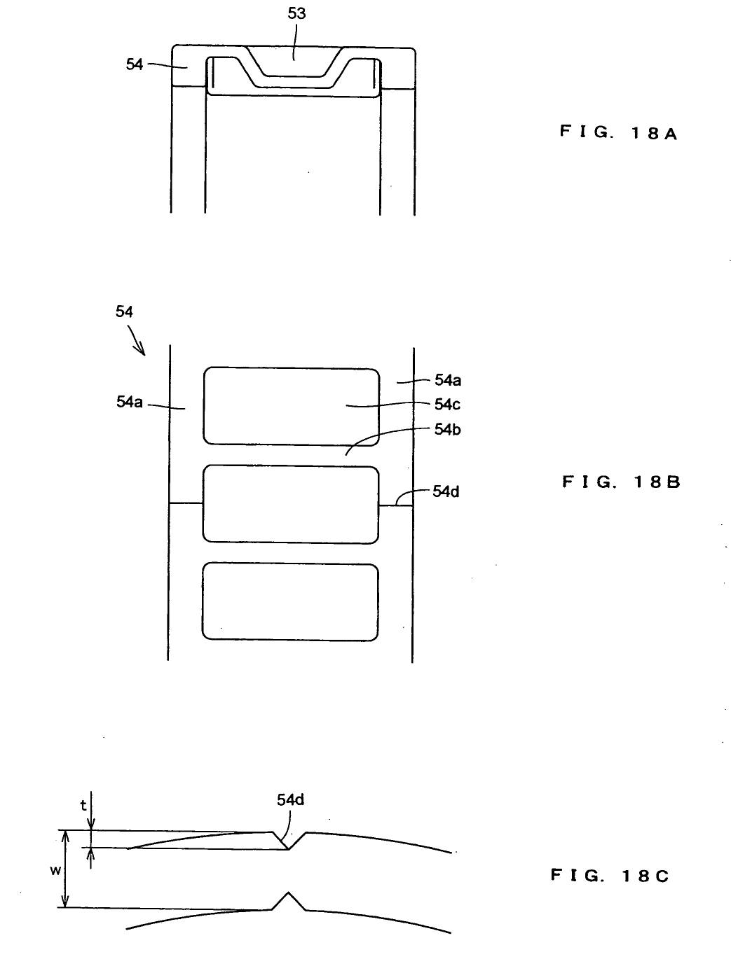

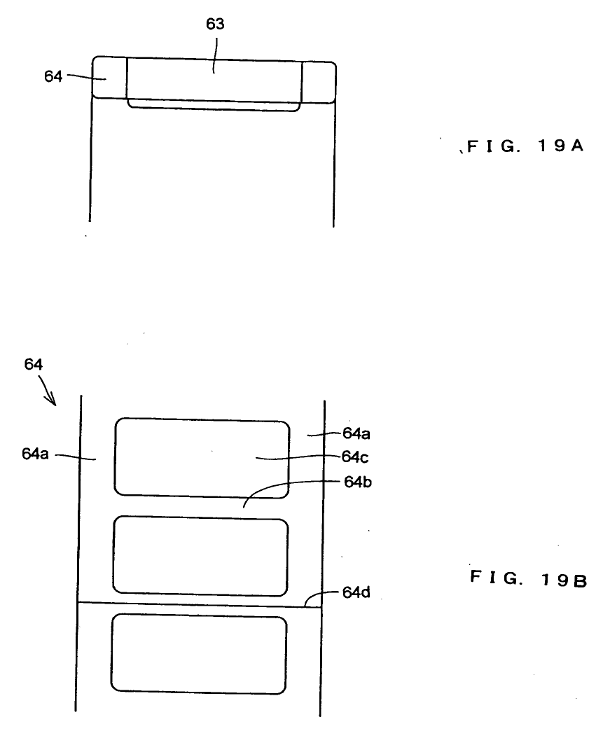

As shown in FIG. 18B, the needle roller bearing 51 comprises an outer ring having a plurality of outer ring members 52 divided by parting lines extending in the axial direction of the bearing, a plurality of needle rollers 53 arranged on the track surface of the outer ring such that it can roll, and a divided type of retainer 54 having a plurality of cut parts extending in the axial direction on the circumference. In addition, since the outer ring member 52 is similar to the outer ring members 12a and 12b shown in FIGS. 3A to 3C, its description will be omitted.

The retainer 54 comprises a pair of ring parts, an M-shaped pillar part 54b formed between the pair of ring parts 54a, and a pocket 54c formed between the adjacent pillar parts 54b for housing the needle roller 53 as shown in FIG. 18B, and it is a metal retainer having a roller stopper (not shown) to prevent the needle roller 53 from dropping off, on the wall surface of the pillar part 54b on the side of the pocket 54c. In addition, a V-shape groove extending in the axial direction of the bearing is formed across the pocket 54c. The depth “t” of the V-shaped groove and the thickness “w” of the retainer 54 have the relation such that 0.03≦t/w≦0.15 as shown in FIG. 18C.

As the material for the retainer 54 having the above constitution, carbon steel containing carbon 0.15 to 1.1% such as STKM12C or SCM415 is used, for example and it is quenched to its core part by bright quenching or high-frequency hardening.

Furthermore, as shown in FIGS. 16A and 16B, the quenched retainer 54 is divided from a root part of the V-shaped groove 54d as a base point by applying a shock load to the V-shaped groove 54 using a sharp-pointed tool such as a chisel. In addition, the cut surface may be flattened by grinding or it may be used as it is.

According to the retainer 54 having the above constitution, since it is divided from the root part of the V-shaped groove 54d as a base point, the clearance generated at the cut part can be easily made small. As a result, the needle roller bearing 51 can be manufactured at low cost.

Since the retainer according to the above each embodiment is formed of carbon steel having carbon content of 0.15 to 1.1%, its quenching property and workability can be improved. In addition, when the carbon content is less than 0.15%, a sufficient heat treatment effect cannot be provided and when it is more than 1.1%, the workability is considerably lowered.

Furthermore, since the depth “t” of the V-shaped groove is set within the range such that 0.03≧t/w≧0.15, the appropriate thickness of the retainer can be secured. In addition, when t/w≦0.03, it is difficult to divide the retainer 54 straight along the V-shaped groove 14d, and when 0.15<t/w, the thickness of the retainer 54 is too small to secure its strength.

Although the V-shaped grooves 54d are provided at two positions on the inner side and outer side in the diameter direction on the circumferential surface of the retainer 54 in the above embodiment, it may be provided on either one side or may be provided on both end faces in addition to on both sides of the circumferential surface.

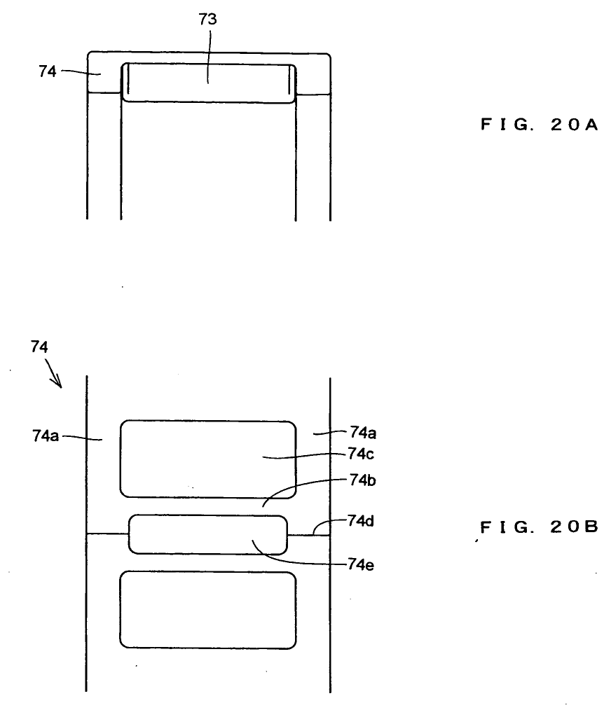

In addition, although the retainer 54 has the M-shaped pillar part 54b in the above embodiment, the present invention is not limited to this. For example, as shown in FIGS. 19A and 19B, the retainer may be a retainer 64 having a straight shaped pillar part 64b, or as shown in FIGS. 20A and 20B, it may be a retainer 74 not having a roller stopper on the inner side in the diameter direction.

Furthermore, although the V-shaped groove 54d is provided across the pocket 54c in the above embodiment, the present invention is not limited to this. For example, as shown in FIG. 19B, a V-shaped groove 64d may be provided at a pillar part 64b, or as shown in FIG. 20B, a V-shaped groove 74d may be provided across a pocket 74e smaller in the axial direction and the circumferential direction than a pocket 74c for housing a needle roller 73.

According to the retainers 54, 64 and 74 shown in FIGS. 18A to 20B, since the configurations of the pillar parts 54b, 64b and 74b and the positions of the V-shaped grooves 54d, 64d and 74d have no relation to each other, they can be combined arbitrarily. In addition, since the basic configuration of the retainers 64 and 74 shown in FIG. 19A to 20B is the same as that of the retainer 54 shown in FIGS. 18A to 18C, its description will be omitted.

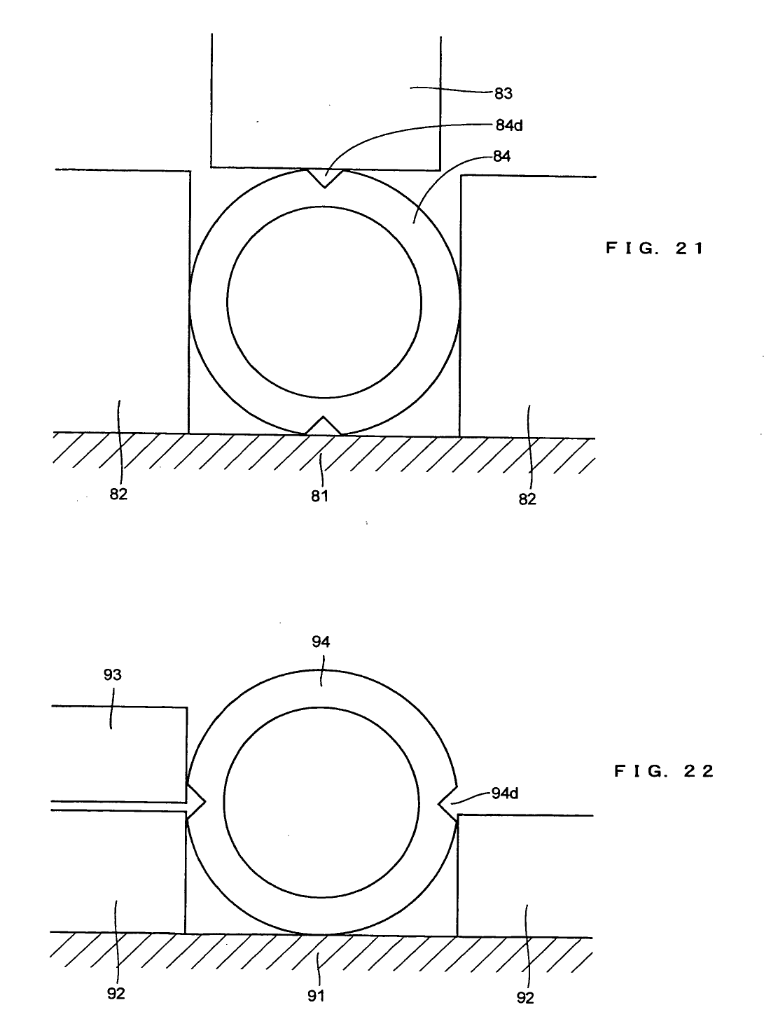

Although the retainer 54 is cut with the sharp-pointed tool 57 such as the chisel in the above embodiment, the present invention is not limited to this. For example, it may be cut by methods shown in FIGS. 21 and 22 .

According to the cutting method shown in FIG. 21, a retainer 84 is set on a work table 81 such that V-shaped grooves 84d may face toward the vertical direction and its lateral sides are fixed by guides 82 . In this state, when a compression load is applied to the retainer 84 by a punch 83, a stress is concentrated on the root part of the V-shaped groove 64d, so that the retainer 84 is cut from this part as a base point.

In addition, according to the cutting method shown in FIG. 22, a retainer 94 is set on a work table 91 so that V-shaped grooves may face toward the horizontal direction and fixed by guides 92 . In this state, when a shearing load is applied to the upper half part of the retainer 94 by a punch 93 from the horizontal direction, a stress is concentrated on the root part of the V-shaped groove 94d, so that the retainer 94 is cut from this part as a base point.

A method of incorporating the needle roller bearing 51 to the crankshaft 55 will be described hereinafter.

First, the retainer 54 incorporating the needle roller 53 in its pocket previously is prepared. Next, one outer ring member 52a is incorporated in the cylinder block 56a, and one divided-type retainer 54, the crankshaft 55, the other divided-type retainer 54, and the other outer ring member 52a are set thereon. Finally, the bearing cap 56b is incorporated and fixed. According to the above incorporating steps, the bearing can be incorporated into the shaft part whose both ends are sandwiched by the crank arms.

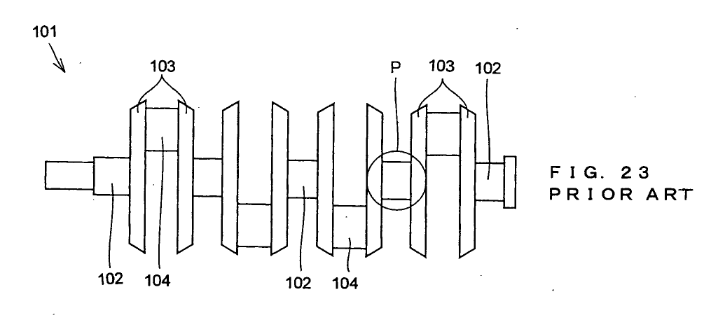

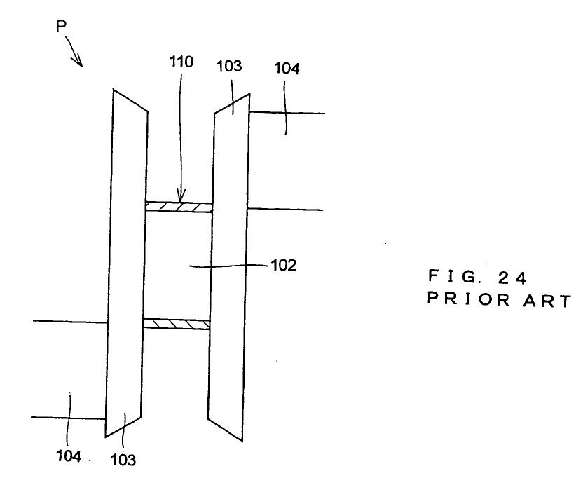

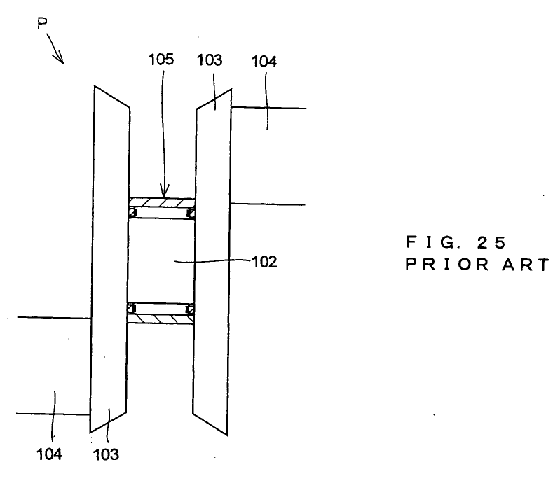

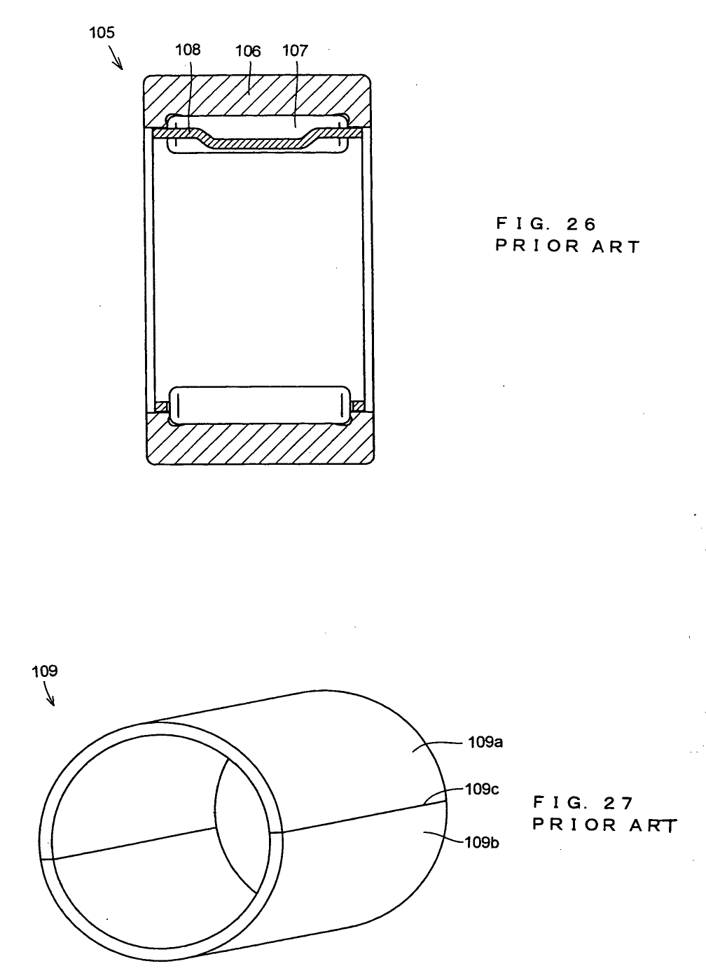

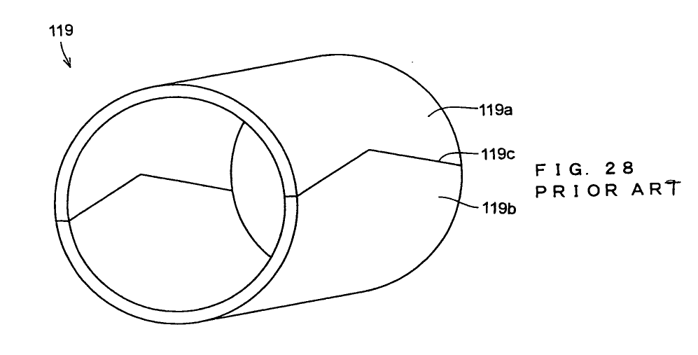

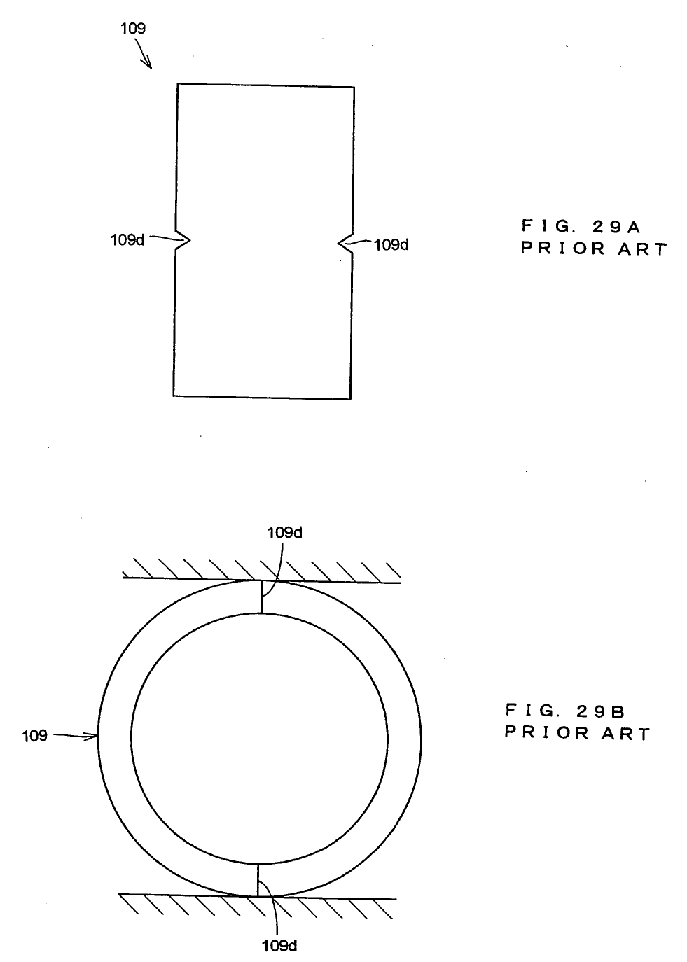

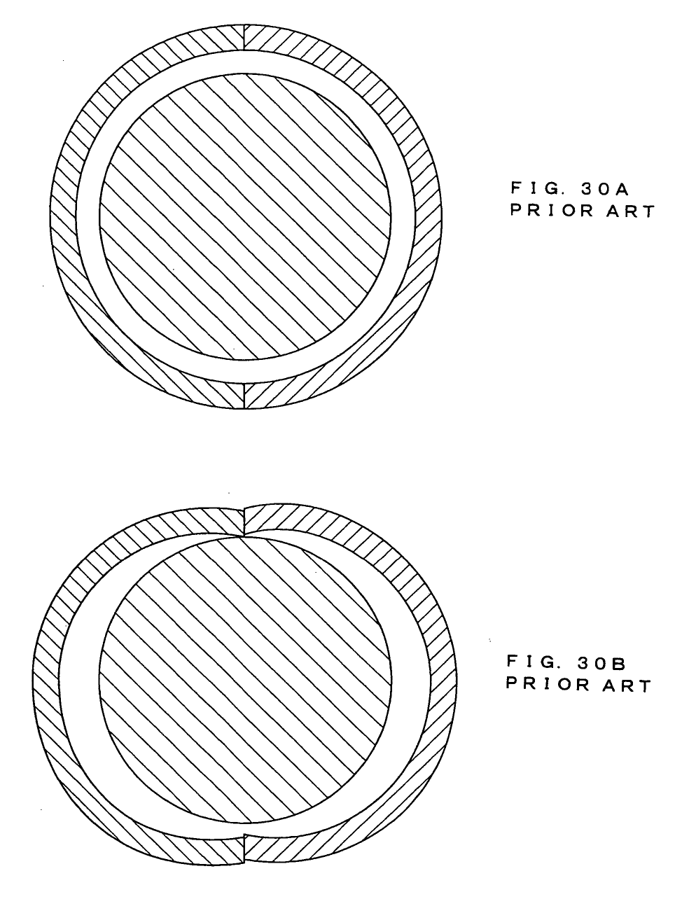

In addition, the crankshaft supporting structure according to the present invention can be applied to various kinds of crankshafts of engines for a car, a two wheel vehicle and the like. In addition, although the number of cylinders may be one or more, when the present invention is applied to the crankshaft used in a multi-cylinder engine having the shaft part whose both ends are sandwiched by the crank arms as shown at the part P in FIG. 23, a greater effect can be expected.

Furthermore, when the characteristic parts in the above embodiments are combined arbitrarily, a synergy effects can be expected in the present invention.

Although the embodiments of the present invention have been described with reference to the drawings in the above, the present invention is not limited to the above-illustrated embodiments. Various kinds of modifications and variations may be added to the illustrated embodiments within the same or equal scope of the present invention.

What is claimed is:

1. A crankshaft supporting structure comprising:
a crankshaft; and
a needle roller bearing supporting said crankshaft rotatably, wherein
said needle roller bearing comprises an outer ring having a plurality of outer ring members divided by parting lines extending in an axial direction of the bearing and a plurality of needle rollers arranged on the track surface of said outer ring such that they can roll, and
the roundness of said outer ring is within the range of 0 to 20 μm.

2. The crankshaft supporting structure according to claim 1, wherein said needle roller bearing comprises:
a track ring and a plurality of rolling elements arranged along the track ring as bearing components, and
at least either one of said bearing components has numerous fine depressions formed on its surface at random.

3. The crankshaft supporting structure according to claim 2, wherein an area ratio of said depressions to a surface area of said bearing component is within the range of 10 to 40%.

4. The crankshaft supporting structure according to claim 2, wherein the surface roughness parameter Sk value of said bearing component is not more than −1.6.

5. The crankshaft supporting structure according to claim 1, wherein said needle roller bearing further comprises a retainer having cut parts extending in the axial direction of the bearing at a plurality of positions on its circumference, and said retainer has a V-shaped groove in section at a position corresponding to said cut part and it is cut at the root part of the groove as a base point.

6. The crankshaft supporting structure according to claim 5, wherein said retainer is formed of carbon steel whose carbon content is not less than 0.15% but not more than 1.1%.

7. The crankshaft supporting structure according to claim 5, wherein the depth “t” of said groove and the thickness “w” of said retainer has a relation such that 0.03≦t/w≦0.15.
